(19) United States
(12) Patent Application Publication
(10) Pub. No.: US 2022/0082393 A1
(43) Pub. Date: Mar. 17, 2022

(54) TRAVEL RECOMMENDATION METHOD, ELECTRONIC DEVICE, AND STORAGE MEDIUM

(71) Applicant: Beijing Baidu Netcom Science Technology Co., Ltd., Beijing (CN)

(72) Inventors: Hao LIU, Beijing (CN); Ding ZHOU, Beijing (CN); Tong XU, Beijing (CN); Hui XIONG, Beijing (CN)

(21) Appl. No.: 17/533,441

(22) Filed: Nov. 23, 2021

(30) Foreign Application Priority Data
Dec. 17, 2020 (CN) 202011496090.X

(51) Int. Cl. G01C 21/34

(52) U.S. Cl. CPC G01C 21/3423; G01C 21/3484; G01C 21/3461; G01C 21/3476

(57) ABSTRACT

A travel recommendation method, an electronic device, and a storage medium are provided, which are related to artificial intelligence, and particularly relates to fields of depth learning, map navigation and the like. The specific implementation scheme includes: obtaining a travel recommendation model according to constraint conditions and prediction conditions, wherein the constraint conditions are used for characterizing travel fairness for different types of users travelling at different moments and in different regions, and the prediction conditions are used for characterizing at least two travel modes selected by the different types of users; and obtaining travel recommendation information according to a travel target and the travel recommendation model.

### CROSS-REFERENCE TO RELATED APPLICATIONS

This application claims priority to Chinese patent application, No. 202011496090.X, entitled “Travel Recommendation Method and Apparatus, Electronic Device, and Storage Medium”, filed with the Chinese Patent Office on Dec. 17, 2020, which is hereby incorporated by reference in its entirety.

### TECHNICAL FIELD

The present disclosure relates to a field of artificial intelligence. The disclosure relates particularly to fields of depth learning, map navigation, and the like.

### BACKGROUND

In order to meet the increasing demands of travel diversification, a travel recommendation scheme can be designed for users with different travel preferences.

### SUMMARY

According to the present disclosure, it is provided a travel recommendation method and apparatus, an electronic device, and a storage medium.

According to an aspect of the disclosure, it is provided a travel recommendation method, including:

obtaining a travel recommendation model according to constraint conditions and prediction conditions, wherein the constraint conditions are used for characterizing travel fairness for different types of users travelling at different moments and in different regions, and the prediction conditions are used for characterizing at least two travel modes selected by the different types of users; and

obtaining travel recommendation information according to a travel target and the travel recommendation model.

According to another aspect of the present disclosure, it is provided a travel recommendation apparatus, including:

a first model recommendation module used for obtaining a travel recommendation model according to constraint conditions and prediction conditions, wherein the constraint conditions are used for characterizing travel fairness for different types of users travelling at different moments and in different regions, and the prediction conditions are used for characterizing at least two travel modes selected by the different types of users;

a travel recommendation module used for obtaining travel recommendation information according to a travel target and the travel recommendation model.

According to another aspect of the present disclosure, it is provided an electronic device, including:

at least one processor; and

a memory communicatively connected to the at least one processor, wherein

the memory stores instructions executable by the at least one processor, and the instructions are executed by the at least one processor to enable the at least one processor to execute the method provided by any one of embodiments of the present disclosure.

According to another aspect of the present disclosure, there is provided a non-transitory computer-readable storage medium storing computer instructions, the computer instructions, when executed by a computer, cause the computer to execute the method as provided in any one of embodiments of the present disclosure.

According to another aspect of the present disclosure, there is provided a computer program product including computer instructions which, when executed by a processor, implement a method as described in any one of embodiments provided herein.

It is to be understood that the content described in this section is not intended to identify the key or critical features of embodiments of the present disclosure, nor is it intended to limit the scope of the disclosure. Other features of the present disclosure will become readily apparent from the following description.

### BRIEF DESCRIPTION OF THE DRAWINGS

The accompanying drawings are included to provide a better understanding of the scheme and are not to be construed as limiting the present disclosure. In the drawings:

FIG. 1 is a schematic flowchart of a travel recommendation method according to an embodiment of the present disclosure;

FIG. 2 is a schematic diagram of time and space distribution of travel mode according to an embodiment of the present disclosure;

FIG. 3 is a schematic diagram showing composition and structure of a travel recommendation apparatus according to an embodiment of the present disclosure;

FIG. 4 is a schematic diagram showing another composition and structure of a travel recommendation apparatus according to an embodiment of the present disclosure: and

FIG. 5 is a block diagram of an electronic device for implementing a travel recommendation method of an embodiment of the present disclosure.

### DETAILED DESCRIPTION

The following describes exemplary embodiments of the present disclosure with reference to the accompanying drawings, which includes various details of embodiments of the present disclosure to facilitate understanding and should be considered as merely exemplary. Accordingly, one of ordinary skilled in the art appreciates that various changes and modifications can be made to the embodiments described herein without departing from the scope and spirit of the present disclosure. Similarly, descriptions of well-known functions and structures are omitted from the following description for clarity and conciseness.

The term “and/or”, as used herein, is merely an association that describes an associated object, meaning that there may be three relationships, e.g., A and/or B, that may represent three cases of: A existing alone, A and B existing simultaneously, and B existing alone. As used herein, the term “at least one” means any one of a variety or any combination of at least two of a variety. e.g., including at least one of A, B, and C, that may represent including any one or more elements selected from the group consisting of A, B, and C. The terms “first” and “second” are used herein to refer to and distinguish between a plurality of similar technical terms, and are not intended to be limiting in order or to define only two. e.g., a first feature and a second feature that refer to two categories/two features, wherein the first feature may be one or more, and the second feature may also be one or more.

Further, in the following preferred embodiments, numerous specific details are set forth in order to provide a better understanding of the disclosure. It will be understood by those skilled in the art that the disclosure may be practiced without some of the specific details. In some instances, methods, means, elements, and circuits well known to those skilled in the art have not been described in detail so as not to obscure the subject matter of the disclosure.

In the existing technologies, a travel recommendation scheme is designed for users with different travel preferences, and taking a map travel client as an example, the problem of performance deviation of users with different travel preferences can be solved through a travel recommendation model obtained after model training. The travel recommendation model can be trained by minimizing the loss function, however, when the training set is occupied by a few categories, the influence of other categories on the loss function will be greatly reduced, which results in the model being able to achieve better performance in a few categories but not similar, better performance across all categories. This phenomenon often leads to the neglect of needs of the minority in the travel recommendation model, which leads to the reduction of users and the single category of users. The product demand that provides similar performance recommendations for users with different travel preferences cannot be matched.

The method for realizing the travel mode recommendation through model training is described as follows:

(1) The travel mode recommendation method based on the cost function is that the cost of different travel modes is measured through a preset cost function, and the least cost is selected as recommendation, such as shortest path recommendation and the like. The travel mode recommendation method based on the cost function usually needs to set corresponding rules manually, and the method is generally poor in universality and requires more time for data analysis and cost function design.

(2) It is related herein to a travel mode recommendation method based on machine learning, that is recommending a travel mode through historical travel mode data and task-related loss functions. According to the travel mode recommendation method based on machine learning, through learning the travel mode in the historical data set, the defect that the cost function method is time-consuming and labor-consuming is solved. However, since the difference of user experience performance caused by uneven data distribution is ignored, travel requirements of users of the minority cannot be well guaranteed.

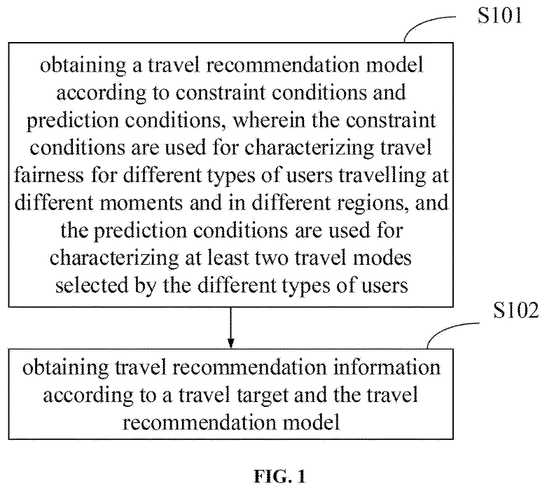

According to an embodiment of the present disclosure, a travel recommendation method is provided. FIG. 1 is a schematic flowchart of a travel recommendation method according to an embodiment of the present disclosure. The method can be applied to a travel recommendation apparatus, for example, the apparatus can be deployed in a terminal or a server or other processing equipment to execute, and can execute fairness-based constraint and travel mode prediction to obtain a travel recommendation model, and obtaining travel recommendation information and the like according to the travel recommendation model. Among other things, the terminal may be user equipment (UE), mobile equipment, a cellular phone, a cordless phone, a personal digital assistant (PDA), handheld equipment, computing equipment, vehicle-mounted equipment, wearable equipment, etc. In some possible implementations, the method may also be implemented by the processor calling computer-readable instructions stored in the memory. As shown in FIG. 1, the method includes:

S101: obtaining a travel recommendation model according to constraint conditions and prediction conditions, wherein the constraint conditions are used for characterizing travel fairness for different types of users travelling at different moments and in different regions, and the prediction conditions are used for characterizing at least two travel modes selected by the different types of users.

S102: obtaining travel recommendation information according to a travel target and the travel recommendation model.

In above-mentioned S101, the constraint conditions (hereinafter referred to as constraint conditions for short) of the travel fairness of different types of users at different moments and in different regions may include constraints of a time dimension and a space dimension, and with such constraint, similar performance can be provided for different types of users traveling at different moments and in different regions.

In above-mentioned S101, the above-mentioned prediction conditions (hereinafter referred to as prediction conditions for short) for characterizing at least two travel modes selected by the different types of users may include prediction of travel mode dimensions, and with such prediction, various travel recommendation schemes may be provided for different types of users traveling at different moments and in different regions.

In above-mentioned S102, the travel recommendation model can be: a model that focuses on travel preferences of minority groups without losing travel preferences of the majority groups, in the training of the model, a tensor including a time dimension, a space dimension and a travel mode dimension can be designed based on the constraint conditions and the prediction conditions to realize the training of the model. Tensors are multilinear mappings defined on Cartesian products of some vector spaces and some dual spaces, such as tensors with multiple dimensions according to “hours”, “regions” and “travel mode statistics” to achieve model training. With the adoption of the model, travel preferences of most users can be met, especially for minority groups, accurate travel recommendations can also be matched, so that travel recommendation schemes can be accurately matched with users with different travel preferences (covering diversification of different types of users of the minority groups and the majority groups), so that user types are rich enough, and recommendation modes are diversified.

By adopting the present disclosure, a travel recommendation model can be obtained according to constraint conditions for characterizing travel fairness of different types of users at different moments and in different regions and prediction conditions for characterizing at least two travel modes selected by the different types of users. Travel recommendation information can be obtained according to a travel target and a travel recommendation model. Due to the fact that the fairness constraint is added, the travel recommendation can pay more attention to the travel preferences of the minority groups without losing the fitting of the travel preferences of the majority groups, and therefore travel scheme recommendations of users with different travel preferences can be accurately matched.

In an embodiment, the constraint conditions for characterizing travel fairness for different types of users at different times and regions are associated is associated with travel time and travel regions; the prediction conditions for characterizing at least two travel modes selected by different types of users are associated with classifications of the at least two travel modes. By adopting this embodiment, the constraint condition is configured to be associated with travel time and travel regions, and the prediction condition is configured to be associated with classification of at least two travel modes, so that a travel recommendation model obtained based on the constraint condition and the prediction condition is better in generalization performance, and travel scheme recommendations of users with different travel preferences can be accurately matched.

In an embodiment, obtaining a travel recommendation model according to constraint conditions for characterizing travel fairness of different types of users at different times and regions and prediction conditions for characterizing at least two travel modes selected by different types of users, including: describing the constraint conditions for characterizing the travel fairness of the different types of users travelling at different moments and in different regions by adopting a space-time loss function; describing the prediction conditions for characterizing the at least two travel modes selected by the different types of users by adopting a double-layer focus loss function; and obtaining a total loss function according to the space-time loss function and the double-layer focus loss function and performing model training according to back propagation of the total loss function, to obtain the travel recommendation model.

In an example, after obtaining a “total loss function” of a travel recommendation model for model training according to the space-time loss function and the double-layer focus loss function, performing model training according to the back propagation of the “total loss function”, and obtaining the travel recommendation model after the training is finished. Then, the travel recommendation model is applied to the travel recommendation scheme of the present disclosure, that is, the required travel recommendation information can be directly output by combining the travel recommendation model according to the travel target input into the travel recommendation model.

By adopting the embodiment, as the constraint conditions are described through the space-time loss function, the constraint on the recommended “quantity” for the different types of users can be realized, and the prediction conditions are described through the double-layer focus loss function, the constraint on the recommended “quality” for the different types of users can be realized, so that the recommendation results with similar performances can be provided for the users with different travel preferences. Finally, users with different travel preferences are accurately matched (covering, diversification of different types of users of majority groups and minority groups), so that the user categories are rich enough, and recommendation modes are diversified.

In an embodiment, the method further includes: obtaining a temporal dimension loss function and a spatial area dimension loss function during a process of network training on a constraint network according to a first sample training set of the constraint network input in the travel recommendation model; and obtaining the space-time loss function according to the temporal dimension loss function and the spatial area dimension loss function, wherein the first sample training set includes sample training data for characterizing different travel moments of different types of users and sample training data for characterizing different travel regions of the different types of users. By adopting the embodiment, aiming at the training on the constraint network in the travel recommendation model, the training of the constraint network can be carried out through the space-time loss function, so that the constraint conditions are described through the space-time loss function, and the constraint, of the recommended “quantity” of different types of users can be realized.

In an embodiment, the method further includes: obtaining the temporal dimension loss function according to a predicted recommended amount at a target moment for a travel mode and an actual demand amount at the target moment for the travel mode. By adopting the embodiment, aiming at the training on the constraint network in the travel recommendation model, the temporal dimension loss function can be obtained. For the temporal dimension loss function, the calculation loss between the predicted value and the real value is calculated, the smaller the loss is, the more accurate the prediction is, the more accurate the space-time loss function is finally obtained based on the temporal dimension loss function and the spatial area dimension loss function. Therefore, the more accurate the result of model training is, the more accurate enough diversified travel recommendations for different types of users can be obtained based on the model.

In an embodiment, the method further includes: obtaining the spatial area dimension loss function according to a predicted recommended amount of a target region for a travel mode and an actual demand amount of the target region for the travel mode. By adopting the embodiment, aiming at the training on the constraint network in the travel recommendation model, the spatial area dimension loss function can be obtained. For the spatial area dimension loss function, the calculation loss between the predicted value and the real value is calculated, the smaller the loss is, the more accurate the prediction is, the more accurate the space-time loss function is finally obtained based on the temporal dimension loss function and the spatial area dimension loss function. Therefore, the more accurate the result of model training is, the more accurate enough diversified travel recommendations for different types of users can be obtained based on the model.

In an embodiment, the method further includes: constructing the travel recommendation model by acquiring output data of the constraint network, taking the output data as input data of a prediction network, and synthesizing the constraint network and the prediction network, wherein the double-layer focus loss function is obtained during a process of network training on the prediction network.

In an example, a multitasking learning mechanism may be introduced, focus loss operations may be performed separately for each travel mode to predict at least two outputs of a prediction network corresponding to each travel mode, and a double-layer focus loss function may be obtained based on the at least two outputs of the prediction network.

According to the embodiment, a prediction network (a network model for realizing prediction of at least two travel modes selected by different types of users, such as a wide & deep model) is added, so that the prediction network and a constraint network (a network model for realizing constraint of travel fairness of different types of users) together form a travel recommendation model. Based on the travel recommendation model, travel scheme recommendations of users with different travel preferences can be accurately matched.

### Application Example

A processing flow applying an embodiment of the present disclosure includes following contents:

in an application example, in order to accurately match the travel schemes of users with different travel preferences, time fairness constraints and space fairness constraints can be designed, so that the travel recommendation model can maintain similar performances in different time and space dimensions, and further can provide similar performances for users traveling at different moments and in different regions. Then, by designing the double-layer focus loss function, on the basis of wide & deep, it is further ensured that travel recommendation can have similar performance in different categories. Finally, the travel recommendation can meet various users with different travel preferences through fairness constraint and double-layer focus loss functions in time and space.

The specific implementation scheme is described as follows:

I. Travel Fairness Constraint of Time and Space Dimensions;

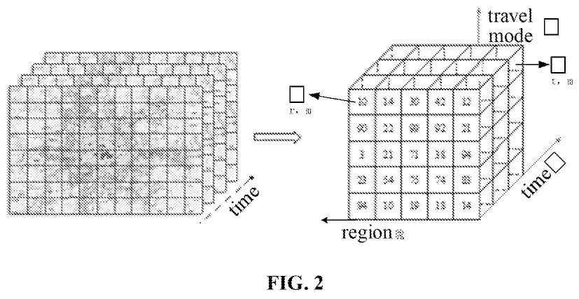

In the context of travel mode recommendations, users tend not to be sufficiently uniform in time and space distribution, which results in more user requests during peak hours and more requests in urban centers. The non-uniformity of the data can lead to insufficient training for users with minority travel preferences to achieve recommendation performance similar to those of users during peak time and in urban centers. FIG. 2 is a schematic diagram of the time and space distribution of travel mode in accordance with an embodiment of the present disclosure. As shown in FIG. 2, a tensor of dimensions “time”, “region”, “travel mode statistics” may be constructed.

In order to make a user get satisfied recommendation at any moment and in any region, it is firstly constructed “fairness constraint based on rethonal recommendation quantity” in the time dimension, hoping that the demand of different regions can get the response of recommendation system. Specifically, the following equations (1)-(3) are used to constrain the travel recommendation model, so that the recommendation quantity in different regions should meet the actual needs as much as possible, i.e., RRF should be as small as possible.

$$\begin{matrix}RRF = {max}_{r ∈ R} ( u ( r ) ) - {min}_{r ∈ R} ( u ( r ) ) & ( 1 ) \\ u ( r , m ) Re LU = ( \frac{{c}_{r , m} -}{{c}_{r , m}} ) & ( 2 ) \\ u ( r ) = \frac{{\sum }_{m ∈ M} u ( r , m )}{{\sum }_{m ∈ M} sign ( u ( r , m ) )} & ( 3 )\end{matrix}$$

In formulas (1)-(3), RRF is the recommendation quantity in different regions; [symbol] is the predicted recommendation quantity of the target region r in the travel mode m;c_{r,m} is the actual quantity demand of the target region r in the travel mode m; u(r, m) is an activation function of a space region dimension; u(r) is the recommendation probability of different regions obtained based on the activation function of the space region dimension, so that u(r) can reflect the neglected degree of region r, and then the recommendation probability can be reflected through RRF: the travel recommendation model recommends unfairness in recommendation quantity between regions.

In the same way as above, the unfair phenomenon of the travel recommendation model in the time dimension can also be defined, namely the following equations (4)-(6) are used for constraining the travel recommendation model, so that the recommendation quantity at different moments should meet the actual requirement as much as possible, namely TRF should be as small as possible.

$$\begin{matrix}TRF = {max}_{t ∈ T} ( u ( t ) ) - {min}_{t ∈ T} ( u ( t ) ) & ( 4 ) \\ u ( t ) = \frac{{\sum }_{m ∈ M} u ( t , m )}{{\sum }_{m ∈ M} sign ( u ( t , m ) )} & ( 5 ) \\ u ( t , m ) Re LU = ( \frac{{c}_{t , m} - \hat{{c}_{t , m}}}{{c}_{t , m}} ) & ( 6 )\end{matrix}$$

In formulas (4)-(6), TRF is the recommendation quantity at different moments; [symbol] is the predicted recommendation quantity of the target moment t in the travel mode m;c_{t,m} is the actual quantity demand of the target moments t in the travel mode m; u(t, m) is an activation function of a time dimension; u(t) is the recommendation probability of different moments obtained based on the activation function of the time dimension, so that u(t) can reflect the neglected degree of time t, and then the recommendation probability can be reflected through TRF: the travel recommendation model recommends unfairness in recommendation quantity between moments.

Based on RRF and TRF, a recommendation quantity fairness loss function in time and space is introduced to guide the travel recommendation model to select a fairer mode to provide the same user experience for travel requests at different moments and in different regions. Specifically, the following equations (7)-(8) are used to find the loss function where the mean of u(r) and the mean of u(t) on the training set are both as small as possible, in which equations (7)-(8), [symbol] _{RRFR} is the spatial area dimension loss function and L_{TR FR} is the temporal dimension loss function.

$$\begin{matrix}{ℒ}_{ℛℛℱℛ} = {λ}_{R R F R} \frac{{\sum }_{r ∈ R} u ( r )}{\vert R \vert} \\ & ( 7 ) \\ {ℒ}_{𝒯ℛℱℛ} = {λ}_{TRFR} \frac{{\sum }_{t ∈ T} u ( t )}{\vert T \vert} & ( 8 )\end{matrix}$$

By adopting the following formula (9), the space-time loss function L_{UR}^{P} can be obtained according to the spatial area dimension loss function and the temporal dimension loss function, and the space-time loss function L_{UR}^{P} is taken as: aiming at the constraint conditions of recommended quantity in travel recommendation at different moments and in different regions:

$${ℒ}_{𝒰ℛ}^{𝒫} = {ℒ}_{ℛℛℱℛ} + {ℒ}_{𝒯ℛℱℛ} \qquad ( 9 )$$

II. Multi-Classification Fairness Enhancement Based on a Double-Layer Focus Loss Function:

After the recommendation quantity in the time and space dimensions is constrained, the loss of the travel recommendation model is still more inclined to the categories with more samples in the data set, so the fairness of the multiple categories needs to be enhanced from the output side of the travel recommendation model. Specifically, a prediction network (wide & deep model) can be introduced into a travel recommendation model (including a constraint network), and a multi-task idea is introduced to carry out prediction output for each travel mode respectively. For travel mode m, the output of wide & deep model is:

$$\hat{{y}_{l}^{m}} = σ ( {w}_{w}^{m} {x}_{i} + {w}_{d}^{m} {z}_{{l}_{f}} + b ) \qquad ( 10 )$$

In formula (10), and w_{w}^{m} are weight matrix; xᵢ is a wide portion; z₁_{_{f}} is a deep portion; σ is variance; [symbol] is the two-class output result of the wide & deep model on the travel mode in, the closer [symbol] is to 1, the more likely m represents the current travel mode. Based on this, the first focus loss function [symbol] is obtained by using the focus function for the two-class method of each travel mode by using the formula (11), so that each two-class can spend more effort processing indistinguishable samples.

$${ℒ}_{𝒷𝒾𝓃𝒶𝓇𝓎}^{𝒟} = - \frac{1}{\vert D \vert \vert M \vert} {\sum }_{m - M} ( {α}_{m} {{y}_{i}^{m} ( 1 - \hat{{y}_{l}^{m}} )}^{γ} log \hat{{y}_{l}^{m}} + ( 1 - {α}_{m} ) ( 1 - {y}_{i}^{m} ) {( \hat{{y}_{l}^{m}} )}^{γ} log ( 1 - \hat{{y}_{l}^{m}} ) ) \qquad ( 11 )$$

Further, in a practical application scenario, a user often selects only one of a plurality of travel modes at the same time, so that for each task in a multi-task, a focus loss needs to be used on the plurality of travel modes, a second focus loss function Lᵣₑₗₐₜᵢₒₙ^{D} can be obtained by using a formula (12), and a double-layer focus loss function is formed by the second focus loss function and the first focus loss function.

$${ℒ}_{𝓇ℯℓ𝒶𝓉𝒾ℴ𝓃}^{𝒟} = - \frac{1}{\vert D \vert \vert M \vert} {\sum }_{i ∈ 𝒟} {\sum }_{m ∈ M} {β}_{m} {{y}_{i}^{m} ( 1 - \hat{{y}_{l}^{m}} )}^{γ} log \hat{{y}_{l}^{m}} \qquad ( 12 )$$

In summary, by using the focus loss function for each travel mode and between multiple travel modes, to a certain extent, the problem that the model tends to a category with more samples is alleviated, and the use experience of users with different travel preferences is greatly improved.

III. Model Training

In case that a model is trained, the total loss function used is calculated by adopting formulas (13)-(14), which consists of recommended quantity constraints in space and time, namely the space-time loss function L_{UR}^{P} and the double-layer focus loss function L_{UE}^{D}, and parameters of the model can be updated on the basis of the following loss functions by using a self-adaptive learning rate gradient descent method.

$$\begin{matrix}ℒ = {ℒ}_{𝒰ℛ}^{𝒫} + {ℒ}_{𝒰ℰ}^{𝒟} & ( 13 ) \\ {ℒ}_{𝒰ℰ}^{𝒟} = {ℒ}_{𝒷𝒾𝓃𝒶𝓇𝓎}^{𝒟} + {ℒ}_{𝓇ℯℓ𝒶𝓉𝒾ℴ𝓃}^{𝒟} & ( 14 )\end{matrix}$$

By adopting the application example, the problem that the performance of the travel recommendation model is different for different user preferences can be solved to a certain extent by designing a fairness constraint condition and a double-layer focus loss function. Specifically, the constraint on the recommended quantity of different categories is realized through the constraint condition of fairness, and meanwhile, the constraint on the recommended quality of different categories is realized through the double-layer focus loss function. Compared with the existing technology, by introducing a wide & deep model and a multi-task learning mechanism, the model no longer depends on the design of a cost function, end-to-end mode learning can be directly carried out from a data set, and the time consumption of manual design is greatly reduced. Due to the fact that the fairness constraint and double-layer focus loss function are added, the travel recommendation can pay more attention to the travel preferences of the minority groups without losing the fitting of the travel preferences of the majority groups. This enables the model to serve more groups with better generalization capabilities.

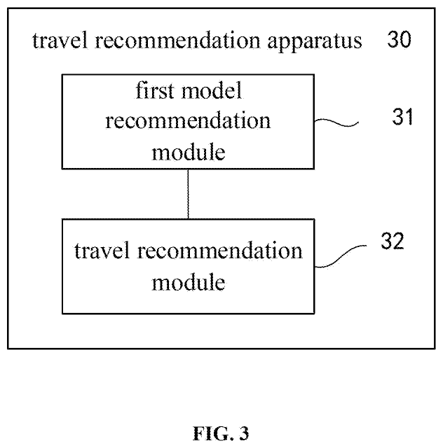

According to an embodiment of the present disclosure, a travel recommendation apparatus 30 is provided. FIG. 3 is a schematic diagram showing composition and structure of a travel recommendation apparatus according to an embodiment of the present disclosure. As shown in FIG. 3, the apparatus includes: a first model recommendation module 31 used for obtaining a travel recommendation model according to constraint conditions and prediction conditions, wherein the constraint conditions are used for characterizing travel fairness for different types of users travelling at different moments and in different regions, and the prediction conditions are used for characterizing at least two travel modes selected by the different types of users; and a travel recommendation module 32 used for obtaining travel recommendation information according to a travel target and the travel recommendation model.

In an embodiment, the first model recommendation module 31 is used for: associating the constraint conditions for characterizing the travel fairness for the different types of users travelling at different moments and in different regions with travel time and travel regions; and associating the prediction conditions for characterizing the at least two travel modes selected by the different types of users with classifications of the at least two travel modes.

In an embodiment, the first model recommendation module 31 is used for: describing the constraint conditions for characterizing the travel fairness of the different types of users travelling at different moments and in different regions by adopting a space-time loss function; describing the prediction conditions for characterizing the at least two travel modes selected by the different types of users by adopting a double-layer focus loss function; and obtaining a total loss function according to the space-time loss function and the double-layer focus loss function and performing model training according to back propagation of the total loss function, to obtain the travel recommendation model.

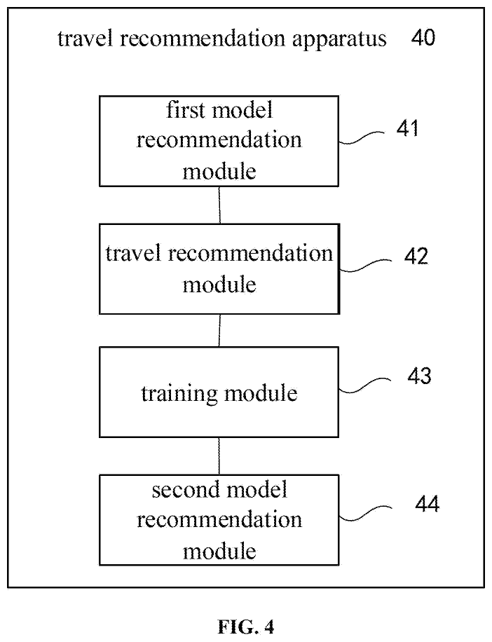

According to an embodiment of the present disclosure, a travel recommendation apparatus 40 is provided, which is identical or similar to the travel recommendation apparatus 30. FIG. 4 is a schematic diagram showing composition and structure of a travel recommendation apparatus according to an embodiment of the present disclosure. As shown in FIG. 4, in addition to a first model recommendation module 41 and a travel recommendation module 42, which are identical or similar to the first model recommendation module 31 and the travel recommendation module 32, the apparatus further includes a training, module 43 used for: obtaining a temporal dimension loss function and a spatial area dimension loss function during a process of network training on a constraint network according to a first sample training set of the constraint network input in the travel recommendation model; and obtaining the space-time loss function according to the temporal dimension loss function and the spatial area dimension loss function, wherein the first sample training set includes sample training data for characterizing different travel moments of different types of users and sample training data for characterizing different travel regions of the different types of users.

In an embodiment, the training module 43 is used for: obtaining the temporal dimension loss function according to a predicted recommended amount at a target moment for a travel mode and an actual demand amount at the target moment for the travel mode.

In an embodiment, the training module 43 is used for: obtaining the spatial area dimension loss function according to a predicted recommended amount of a target region for a travel mode and an actual demand amount of the target region for the travel mode.

In an embodiment, FIG. 4 is a schematic diagram showing another composition and structure of a travel recommendation apparatus according to an embodiment of the present disclosure. As shown in FIG. 4, the apparatus further includes a second model recommendation module 44 used for: constructing the travel recommendation model by acquiring output data of the constraint network, taking the output data as input data of a prediction network, and synthesizing the constraint network and the prediction network; wherein the double-layer focus loss function is obtained during a process of network training on the prediction network.

The function of each module in each apparatus of embodiment of the disclosure can be referred to corresponding descriptions in the above-mentioned method, which will not be described in detail herein.

In accordance with embodiments of the present disclosure, the present disclosure also provides an electronic device, a readable storage medium, and a computer program product.

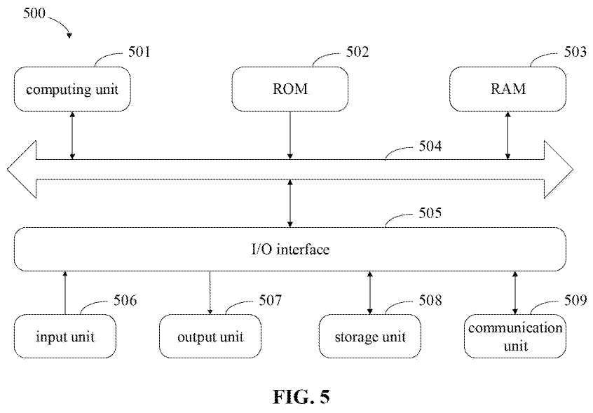

As shown in FIG. 5, it is a block diagram of an electronic device for implementing a travel recommendation method of an embodiment of the present disclosure. The electronic device may be deployment equipment or proxy equipment as described above. The electronic device is intended to represent various forms of digital computers, such as a laptop computer, desktop computer, workstation, personal digital assistant, server, blade server, mainframe computer, and other suitable computers. The electronic device may also represent various forms of mobile devices, such as personal digital processing, cellular telephone, smart phone, wearable equipment, and other similar computing devices. The parts, connections, and relationships thereof, and functions thereof shown herein are by way of example only and are not intended to limit the implementations of the disclosure described and/or claimed herein.

As shown in FIG. 5, the device 500 includes a computing unit 501 that may perform various suitable actions and processes in accordance with a computer program stored in a read only memory (ROM) 502 or a computer program loaded from a storage unit 508 into a random-access memory (RAM) 503. In the RAM 503, various programs and data required for the operation of the memory device 500 can also be stored. The computing unit 501, the ROM 502 and the RAM 503 are connected to each other through a bus 504. An input output (I/O) interface 505 is also connected to bus 504.

A number of components in equipment 500 are connected to I/O interface 505, including: an input unit 506, such as a keyboard, a mouse; an output unit 507, such as various types of displays, speakers; a storage unit 508, such as a magnetic disk, an optical disk; and a communication unit 509, such as a network card, a modem, a wireless communication transceiver. The communication unit 509 allows the device 500 to exchange information/data with other devices over a computer network, such as the Internet, and/or various telecommunications networks.

Computing unit 501 may be various general purpose and/or special purpose processing assemblies having processing and computing capabilities. Some examples of computing unit 501 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 501 performs various methods and processes described above, such as a travel recommendation method. For example, in some embodiments, the travel recommendation method may be implemented as a computer software program that is physically contained in a machine-readable medium, such as storage unit 508. In some embodiments, some or all of the computer programs may be loaded into and/or installed on equipment 500 via ROM 502 and/or communication unit 509. When a computer program is loaded into RAM 503 and executed by computing unit 501, one or more of the steps of the travel recommendation method described above may be performed. Alternatively, in other embodiments, computing unit 501 may be configured to perform the travel recommendation method in any other suitable manner (e.g., via firmware).

Various implementations of the systems and techniques described herein above may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or combinations thereof. These various embodiments may include an implementation in one or more computer programs, which can be executed and/or interpreted on a programmable system including at least one programmable processor; the programmable processor can be a dedicated or general-purpose programmable processor, which can receive data and instructions from, and transmit data and instructions to, a memory system, at least one input device, and at least one output device.

Program codes for implementing methods of the present disclosure may be written in any combination of one or more programming languages. These program codes may be provided to a processor or a controller of a general-purpose computer, a special purpose computer, or other programmable data processing units, such that program codes, when executed by the processor or the controller, cause functions/operations specified in a flowchart and/or a block diagram to be performed. The program codes may be executed entirely on a machine, partly on a machine, partly on a machine as a stand-alone software package and partly on a remote machine, or entirely on a remote machine or a server.

In the context of the present disclosure, a machine-readable medium can be a tangible medium that may contain or store a program for use by or in connection with an instruction execution system, device, or apparatus. The machine-readable medium may be a machine-readable signal medium or a machine-readable storage medium. The machine-readable medium may include, but is not limited to, electronic, magnetic, optical, electromagnetic, infrared, or semi-conductive systems, devices, or apparatuses, or any suitable combination thereof. More specific examples of the machine-readable storage medium may include one or more wire-based electrical connections, a portable computer diskette, a hard disk, a random-access memory (RAM), a read-only memory (ROM), an erasable programmable read-only memory (EPROM or Flash memory), an optical fiber, a portable compact disk read-only memory (CD-ROM), an optical storage apparatus, a magnetic storage apparatus, or any suitable combination thereof.

In order to provide interactions with a user, the system and technology described herein may be implemented on a computer having a display device (for example, a cathode ray tube (CRT) or a liquid crystal display (LCD) monitor) for displaying information to the user; and a keyboard and pointing device (e.g., a mouse or a trackball) through which a user can provide input to the computer. Other types of devices may also be used to provide an interaction with a user. For example, the feedback provided to a user may be any form of sensory feedback (e.g., visual feedback, auditory feedback, or tactile feedback); and the inputs from a user may be received in any form, including acoustic input, voice input, or tactile input.

The systems and techniques described herein may be implemented in a computing system (for example, as a data server) that includes back-end components, or be implemented in a computing system (for example, an application server) that includes middleware components, or be implemented in a computing system (for example, a user computer with a graphical user interface or a web browser through which the user may interact with the implementation of the systems and technologies described herein) that includes front-end components, or be implemented in a computing system that includes any combination of such back-end components, intermediate components, or front-end components. The components of the system may be interconnected by any form or medium of digital data communication (for example, a communication network). Examples of communication networks include: a Local Area Network (LAN), a Wide Area Network (WAN), the Internet.

The computer system may include a client and a server. The client and the server are generally remote from each other and typically interact through a communication network. The client-server relationship is generated by computer programs that run on respective computers and have a client-server relationship with each other.

It should be understood that various forms of processes shown above may be used to reorder, add, or delete steps. For example, respective steps described in the present disclosure may be executed in parallel, or may be executed sequentially, or may be executed in a different order, as long as the desired result of the technical solution disclosed in the present disclosure can be achieved, to which no limitation is made herein.

The above specific embodiments do not constitute a limitation on the protection scope of the present disclosure. It should be understood by those skilled in the art that various modifications, combinations, sub-combinations, and substitutions may be made according to design requirements and other factors. Any modification, equivalent replacement and improvement, and the like made within the spirit and principle of the present disclosure shall be fall in the protection scope of the present disclosure.

What is claimed is:

1. A travel recommendation method, comprising:
obtaining a travel recommendation model according to constraint conditions and prediction conditions, wherein the constraint conditions are used for characterizing travel fairness for different types of users travelling at different moments and in different regions, and the prediction conditions are used for characterizing at least two travel modes selected by the different types of users; and
obtaining travel recommendation information according to a travel target and the travel recommendation model.

2. The travel recommendation method of claim 1, wherein the constraint conditions for characterizing the travel fairness for the different types of users travelling at different moments and in different regions are associated with travel time and travel regions; and
the prediction conditions for characterizing the at least two travel modes selected by the different types of users are associated with classifications of the at least two travel modes.

3. The travel recommendation method of claim 1, wherein the obtaining the travel recommendation model according to the constraint conditions and the prediction conditions, wherein the constraint conditions are used for characterizing the travel fairness of the different types of users travelling at different moments and in different regions, and the prediction conditions are used for characterizing at least two travel modes selected by the different types of users, comprising:
describing the constraint conditions for characterizing the travel fairness of the different types of users travelling at different moments and in different regions by adopting a space-time loss function;
describing the prediction conditions for characterizing the at least two travel modes selected by the different types of users by adopting a double-layer focus loss function; and
obtaining a total loss function according to the space-time loss function and the double-layer focus loss function and performing model training according to back propagation of the total loss function, to obtain the travel recommendation model.

4. The travel recommendation method of claim 2, wherein the obtaining the travel recommendation model according to the constraint conditions and the prediction conditions, wherein the constraint conditions are used for characterizing the travel fairness of the different types of users travelling at different moments and in different regions, and the prediction conditions are used for characterizing at least two travel modes selected by the different types of users, comprising:
describing the constraint conditions for characterizing the travel fairness of the different types of users travelling at different moments and in different regions by adopting a space-time loss function;
describing the prediction conditions for characterizing the at least two travel modes selected by the different types of users by adopting a double-layer focus loss function; and
obtaining a total loss function according to the space-time loss function and the double-layer focus loss function and performing model training according to back propagation of the total loss function, to obtain the travel recommendation model.

5. The travel recommendation method of claim 3, further comprising:
obtaining a temporal dimension loss function and a spatial area dimension loss function during a process of network training on a constraint network according to a first sample training set of the constraint network input in the travel recommendation model; and
obtaining the space-time loss function according to the temporal dimension loss function and the spatial area dimension loss function,
wherein the first sample training set comprises sample training data for characterizing different travel moments of different types of users and sample training data for characterizing different travel regions of the different types of users.

6. The travel recommendation method of claim 5, further comprising:
obtaining the temporal dimension loss function according to a predicted recommended amount at a target moment for a travel mode and an actual demand amount at the target moment for the travel mode.

7. The travel recommendation method of claim 5, further comprising:
obtaining the spatial area dimension loss function according to a predicted recommended amount of a target region for a travel mode and an actual demand amount of the target region for the travel mode.

8. The travel recommendation method of claim 5, further comprising:
constructing the travel recommendation model by acquiring output data of the constraint network, taking the output data as input data of a prediction network, and synthesizing the constraint network and the prediction network, wherein
the double-layer focus loss function is obtained during a process of network training on the prediction network.

9. An electronic device, comprising:
at least one processor; and
a memory communicatively connected to the at least one processor, wherein
the memory stores instructions executable by the at least one processor, and the instructions are executed by the at least one processor to enable the at least one processor to:
obtain a travel recommendation model according to constraint conditions and prediction conditions, wherein the constraint conditions are used for characterizing travel fairness for different types of users travelling at different moments and in different regions, and the prediction conditions are used for characterizing at least two travel modes selected by the different types of users; and
obtain travel recommendation information according to a travel target and the travel recommendation model.

10. The electronic device according to claim 9, wherein the constraint conditions for characterizing the travel fairness for the different types of users travelling at different moments and in different regions are associated with travel time and travel regions; and
the prediction conditions for characterizing the at least two travel modes selected by the different types of users are associated with classifications of the at least two travel modes.

11. The electronic device according to claim 9, wherein the instructions are executed by the at least one processor to further enable the at least one processor to:
describe the constraint conditions for characterizing the travel fairness of the different types of users travelling at different moments and in different regions by adopting a space-time loss function;
describe the prediction conditions for characterizing the at least two travel modes selected by the different types of users by adopting a double-layer focus loss function; and
obtain a total loss function according to the space-time loss function and the double-layer focus loss function and perform model training according to back propagation of the total loss function, to obtain the travel recommendation model.

12. The electronic device according to claim 10, wherein the instructions are executed by the at least one processor to further enable the at least one processor to:
describe the constraint conditions for characterizing the travel fairness of the different types of users travelling at different moments and in different regions by adopting a space-time loss function;
describe the prediction conditions for characterizing the at least two travel modes selected by the different types of users by adopting a double-layer focus loss function; and
obtain a total loss function according to the space-time loss function and the double-layer focus loss function and perform model training according to back propagation of the total loss function, to obtain the travel recommendation model.

13. The electronic device according to claim 11, wherein the instructions are executed by the at least one processor to further enable the at least one processor to:
obtain a temporal dimension loss function and a spatial area dimension loss function during a process of network training on a constraint network according to a first sample training set of the constraint network input in the travel recommendation model; and
obtain the space-time loss function according to the temporal dimension loss function and the spatial area dimension loss function,
wherein the first sample training set comprises sample training data for characterizing different travel moments of different types of users and sample training data for characterizing different travel regions of the different types of users.

14. The electronic device according to claim 13, wherein the instructions are executed by the at least one processor to further enable the at least one processor to:
obtain the temporal dimension loss function according to a predicted recommended amount at a target moment for a travel mode and an actual demand amount at the target moment for the travel mode.

15. The electronic device according to claim 13, wherein the instructions are executed by the at least one processor to further enable the at least one processor to:
obtain the spatial area dimension loss function according to a predicted recommended amount of a target region for a travel mode and an actual demand amount of the target region for the travel mode.

16. The electronic device according to claim 13, wherein the instructions are executed by the at least one processor to further enable the at least one processor to:
construct the travel recommendation model by acquiring output data of the constraint network, take the output data as input data of a prediction network, and synthesize the constraint network and the prediction network, wherein
the double-layer focus loss function is obtained during a process of network training on the prediction network.

17. A non-transitory computer-readable storage medium storing computer instructions, the computer instructions, when executed by a computer, cause the computer to:
obtain a travel recommendation model according to constraint conditions and prediction conditions, wherein the constraint conditions are used for characterizing travel fairness for different types of users travelling at different moments and in different regions, and the prediction conditions are used for characterizing at least two travel modes selected by the different types of users; and
obtain travel recommendation information according to a travel target and the travel recommendation model.

18. The non-transitory computer-readable storage medium according to claim 17, wherein the constraint conditions for characterizing the travel fairness for the different types of users travelling at different moments and in different regions are associated with travel time and travel regions; and
the prediction conditions for characterizing the at least two travel modes selected by the different types of users are associated with classifications of the at least two travel modes.

19. The non-transitory computer-readable storage medium according, to claim 17, wherein the computer instructions, when executed by a computer, further cause the computer to:
describe the constraint conditions for characterizing the travel fairness of the different types of users travelling at different moments and in different regions by adopting a space-time loss function;
describe the prediction conditions for characterizing the at least two travel modes selected by the different types of users by adopting a double-layer focus loss function; and
obtain a total loss function according to the space-time loss function and the double-layer focus loss function and perform model training according to back propagation of the total loss function, to obtain the travel recommendation model.

20. The non-transitory computer-readable storage medium according to claim 19, wherein the computer instructions, when executed by a computer, further cause the computer to:
obtain a temporal dimension loss function and a spatial area dimension loss function during a process of network training on a constraint network according to a first sample training set of the constraint network input in the travel recommendation model; and
obtain the space-time loss function according to the temporal dimension loss function and the spatial area dimension loss function,
wherein the first sample training set comprises sample training data for characterizing different travel moments of different types of users and sample training data for characterizing different travel regions of the different types of users.
